(19) United States
(12) Patent Application Publication
(10) Pub. No.: US 2024/0079187 A1
(43) Pub. Date: Mar. 7, 2024

(54) Silicon-Based Supercapacitor with Additive-Manufactured Design and Electrodes for Same

(71) Applicant: Georgia Tech Research Corporation, Atlanta, GA (US)

(72) Inventors: Jud Ready, Atlanta, GA (US); Julia Allen, Atlanta, GA (US); Andrew Gunawan, Atlanta, GA (US); Aaron Thomas, Atlanta, GA (US); Deven Saurin Shah, Atlanta, GA (US)

(21) Appl. No.: 18/202,231

(22) Filed: May 25, 2023

Related U.S. Application Data
(60) Provisional application No. 63/365,287, filed on May 25, 2022.

(51) Int. Cl. H01G 11/36; H01G 11/26; H01G 11/52; H01G 11/58

(52) U.S. Cl. CPC H01G 11/36; H01G 11/26; H01G 11/52; H01G 11/58

(57) ABSTRACT

An exemplary embodiment of the present disclosure provides a wearable gait monitoring system for monitoring characteristics of an animal pulling a payload. The system can comprise and inertial measurement unit (IMU), a load sensor, and a display. The IMU can be configured to be positioned proximate the animal and configured to generate IMU data indicative of an acceleration and rotation of the animal. The load sensor can be configured to generate force data indicative of a force exerted on the payload by the animal. The display can be configured to display load and gait information to a user, wherein the load and gait information can be based on the IMU data and the force data.

### CROSS-REFERENCE TO RELATED APPLICATIONS

This application claims the benefit of U.S. Provisional Application Ser. No. 63/365,287, filed on 25 May 2022, which is incorporated herein by reference in its entirety as if fully set forth below.

### GOVERNMENT LICENSE RIGHTS

This invention was made with government support under Agreement No. 80MSFC20M0011, awarded by the National Aeronautics and Space Administration. The government has certain rights in the invention.

### FIELD OF THE DISCLOSURE

The various embodiments of the present disclosure relate generally to capacitors, and more particularly to double-layer capacitors and electrodes that can be used in the same.

### BACKGROUND

With the rise of microelectronics, conventional circuitry is under constant modification, especially the internal electrical components to fit increasingly tight constraints. Electronics has made a shift from micro to nano-scale devices within the past decade. With the increase in the miniaturization, electrical components, such as resistors, batteries, and transistors have been modified and redeveloped to fit the physical and mechanical characteristics of nano-scale electrical environments. Silicon based printed circuit boards have started to shrink in size, utilizing different methods of integrating these miniscule components. Recently, the integration of electrical components within the board itself has been an area of development. In specific, the need for high-energy capacitors has risen.

Capacitors have the capability of holding high charge densities and rapid discharges of energy. This holds ample utilizations within circuitry and device development. However, the reduction of device sizes has rendered conventional components null due to the synonymous energy requirements to present electronics. Electrochemical double layer capacitors (ECM), otherwise known as supercapacitors, allow for higher power and energy than traditional capacitors. Furthermore, carbon nano tube (CNT) based supercapacitors have provided exceeding improvements over ECDLs. Carbon nanotubes have been heavily studied in the development of capacitors. The scale of function of these ECDLs is drastically smaller than conventional capacitors. Furthermore, it has been shown to possess capacitances from 15-200 F/g, depending on the active surface area. This shows great viability for supercapacitor technology using CNTs.

However, there still exist a need for supercapacitors that are capable of being more easily manufactured through, for example, an additive manufacturing design. Some embodiments of the present disclosure provide such supercapacitors.

### BRIEF SUMMARY

An exemplary embodiment of the present disclosure provides a capacitor, comprising a first electrode, a second electrode, an ionic liquid electrolyte, and a spacer. The ionic liquid electrolyte can be positioned between the first and second electrodes. The spacer can be positioned between the first and second electrodes and configured to separate the first electrode from the second electrode.

In any of the embodiments disclosed herein, the spacer, the first electrode, and the second electrode can define an internal cavity, and the ionic liquid electrolyte can be positioned in the internal cavity.

In any of the embodiments disclosed herein, the first and second electrodes can be attached to the spacer via epoxy.

In any of the embodiments disclosed herein, the spacer can comprise a first end, a second end, and an outer perimeter positioned between the first and second ends.

In any of the embodiments disclosed herein, the spacer can comprise a first ledge disposed within the outer perimeter, and the first ledge can be configured to interface with the first electrode.

In any of the embodiments disclosed herein, the first ledge can be a continuous protrusion extending inward towards a center of the spacer from the outer perimeter.

In any of the embodiments disclosed herein, the first ledge can comprise one or more protrusions extending inward towards the center of the spacer from the outer perimeter.

In any of the embodiments disclosed herein, the one or more protrusions can be coplanar.

In any of the embodiments disclosed herein, the capacitor can further comprise a second ledge disposed within the outer perimeter, the second ledge configured to interface with the second electrode.

In any of the embodiments disclosed herein, the second ledge can be a continuous protrusion extending inward towards a center of the spacer from the outer perimeter.

In any of the embodiments disclosed herein, the second ledge can comprise one or more protrusions extending inward towards the center of the spacer from the outer perimeter.

In any of the embodiments disclosed herein, the one or more protrusions can be coplanar.

In any of the embodiments disclosed herein, at least one of the first and second electrodes can comprise a first plurality of carbon nanotubes proximate the ionic liquid electrolyte.

In any of the embodiments disclosed herein, the first plurality of carbon nanotubes can comprise first ends and opposing second ends, and the second ends of the first plurality of carbon nanotubes can be positioned proximate the ionic liquid electrolyte.

In any of the embodiments disclosed herein, the first electrode can comprise the first plurality of carbon nanotubes, and the second electrode can comprise a second plurality of carbon nanotubes proximate the ionic liquid electrolyte.

In any of the embodiments disclosed herein, the first plurality of carbon nanotubes can comprise first ends and opposing second ends, and the second ends of the first plurality of carbon nanotubes can be positioned proximate the ionic liquid electrolyte.

In any of the embodiments disclosed herein, the second plurality of carbon nanotubes can comprise first ends and opposing second ends, and the second ends of the second plurality of carbon nanotubes can be positioned proximate the ionic liquid electrolyte.

In any of the embodiments disclosed herein, the first plurality of carbon nanotubes can be coated with a pseudocapacitive material.

In any of the embodiments disclosed herein, the first plurality of carbon nanotubes can be coated with aluminum oxide.

In any of the embodiments disclosed herein, the first plurality of carbon nanotubes can be coated with titanium dioxide.

In any of the embodiments disclosed herein, the first plurality of carbon nanotubes can be coated with aluminum oxide and titanium dioxide.

In any of the embodiments disclosed herein, the first plurality of carbon nanotubes can be multi-walled carbon nanotubes.

In any of the embodiments disclosed herein, the spacer can be 3D printed.

In any of the embodiments disclosed herein, the first and second electrodes can be coated with titanium dioxide, aluminum oxide, or combinations thereof.

Another embodiment of the present disclosure provides a capacitor comprising a first electrode, a second electrode, and a spacer. The spacer can be positioned between and separate the first and second electrodes. The spacer can comprise a first side, a second side, and an outer perimeter. The first side of the spacer can be coupled to the first electrode. The second side of the spacer can be coupled to the second electrode. The outer perimeter of the spacer can be between the first and second sides. The outer perimeter, first electrode, and second electrode can form an internal cavity containing a ionic liquid electrolyte.

In any of the embodiments disclosed herein, the spacer can further comprise a first ledge disposed on an interior surface of the outer perimeter, and the first ledge can be configured to interface with the first electrode.

In any of the embodiments disclosed herein, the spacer can further comprise a second ledge disposed on an interior surface of the outer perimeter, and the second ledge can be configured to interface with the second electrode.

Another embodiment of the present disclosure provides an electrode for use in a capacitor. The electrode can comprise a conductive substrate and a plurality of carbon nanotubes. The plurality of carbon nanotubes can be adjacent a first side of the conductive substrate. The plurality of carbon nanotubes can be coated with aluminum oxide and titanium dioxide.

In any of the embodiments disclosed herein, the first and second pluralities of carbon nanotubes can be multi-walled carbon nanotubes.

In any of the embodiments disclosed herein, each of the plurality of carbon nanotubes can comprise a first coating of the aluminum oxide and a second coating of the titanium oxide.

In any of the embodiments disclosed herein, each of the plurality of carbon nanotubes can be arranged substantially parallel to another carbon nanotube.

In any of the embodiments disclosed herein, each of the plurality of carbon nanotubes can be arranged substantially perpendicular to the conductive substrate.

In any of the embodiments disclosed herein, the electrode can further comprise a plurality of catalyst patches positioned between the plurality of carbon nanotubes and the first side of the conductive substrate.

In any of the embodiments disclosed herein, each of the catalyst patches can comprise a catalyst layer.

In any of the embodiments disclosed herein, the catalyst layer can comprise a material selected from the group consisting of iron, nickel, cobalt, and combinations thereof.

In any of the embodiments disclosed herein, each of the plurality of catalyst patches further comprises at least one layer comprising a material selected from the group consisting of aluminum, titanium, and combinations thereof.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic of a capacitor, in accordance with some exemplary embodiments of the present disclosure.

FIGS. 2A & 2B provide perspective and side cross-sectional views, respectively, of a spacer, in accordance with some exemplary embodiments of the present disclosure.

FIGS. 3A-C provide top views of spacers, in accordance with some exemplary embodiments of the present disclosure.

FIG. 4 provides a flow diagram of a process for assembling a capacitor, in accordance with some exemplary embodiments of the present disclosure.

FIG. 5A provides an image of vertically oriented carbon nanotubes, and FIG. 5B provides an image of a multi-walled carbon nanotube, in accordance with some embodiments of the present disclosure.

FIG. 6 provides an image of a carbon nanotube coated with aluminum dioxide and titanium dioxide, in accordance with some embodiments of the present disclosure.

FIGS. 7A-B provide plots of voltage over time for uncoated and alumina/titania-coated multiwalled carbon nanotubes, respectively.

FIGS. 8A-B provide plots of voltage over time for titania-coated and alumina/titania-coated multiwalled carbon nanotubes, respectively.

FIG. 9 provides a plot of power density and energy density for various conventional capacitors and an exemplary capacitor of the present disclosure utilizing electrodes with titania/alumina-coated multiwall carbon nanotubes.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The present disclosure provides a novel chip-scale electrochemical double-layer (ECDL) supercapacitor that can use carbon nanotubes to provide high-power energy storage for low-volume and low-weight microelectronics systems. Traditional ECDL approaches that utilize activated carbon often have limitations imposed by the structure of their pores. The capacitors disclosed herein, however, can employ nanostructured electrodes that offer improved performance due to their high surface area, high conductivity, increased porosity, and options for functionalization that enhance pseudocapacitance (i.e., electrochemical storage of electricity). The capacitors disclosed herein can utilize an innovative construction which can allow part of the fabrication process to completed with additive manufacturing instead of traditional microelectronics fabrication processes.

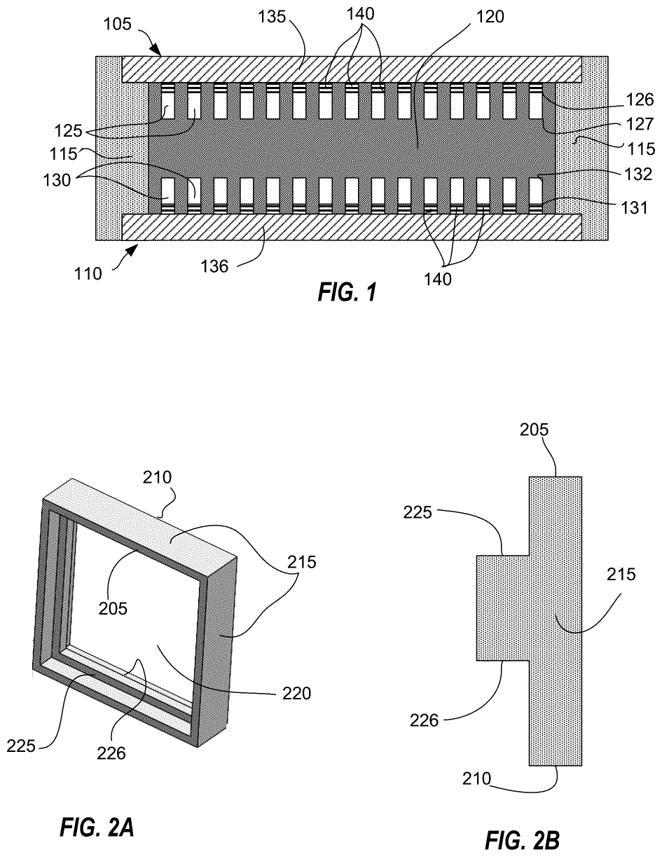

As shown in FIG. 1, an exemplary embodiment of the present disclosure provides a capacitor comprising a first electrode 105, a second electrode 110, an ionic liquid electrolyte 120, and a spacer 115. The ionic liquid electrolyte 120 can be positioned between the first 105 and second 110 electrodes. The spacer 115 can be positioned between the first 105 and second 110 electrodes and configured to separate the first electrode 105 from the second electrode 110. As shown in FIG. 1, the spacer 115, the first electrode 105, and the second electrode 110 can together define an internal cavity, and the ionic liquid electrolyte 120 can be positioned in the internal cavity.

The first 105 and second 110 electrodes can be attached to the spacer 115 many different ways. In some embodiments, the first 105 and second 110 electrodes can be attached to the spacer via epoxy.

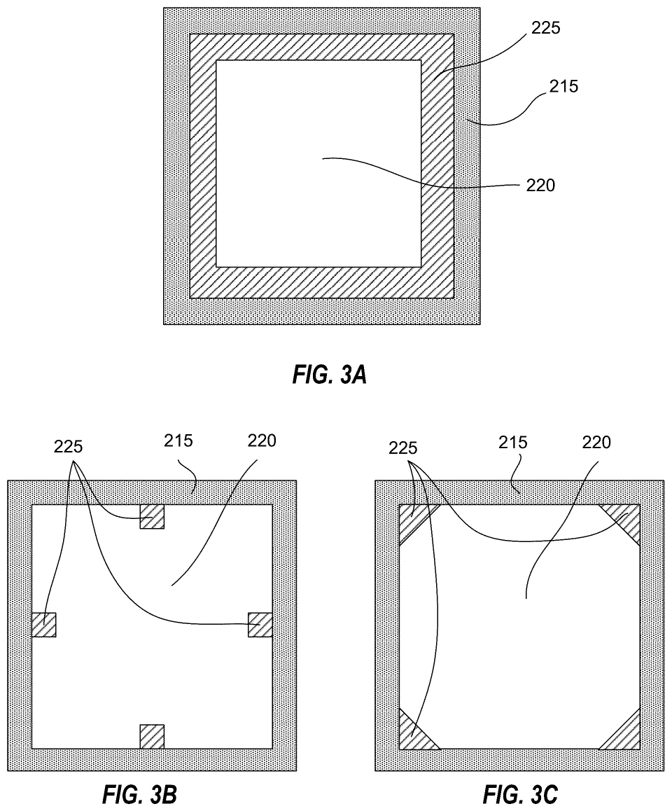

FIG. 2A and FIG. 2B provide perspective cross-sectional views of an exemplary spacer, respectively. FIGS. 3A-C provide top views exemplary spacers. The spacer can comprise a first end 205, a second end 210, and an outer perimeter 215 positioned between the first 205 and second 210 ends. The outer perimeter 215 (along with the first 105 and second 110 electrodes) can define an internal cavity 220 that can contain the ionic liquid electrolyte. The spacer can further comprise a first ledge 225 disposed within the outer perimeter 215. The first ledge can be configured to interface with the first electrode 105. The spacer can also further comprise a second ledge 226 disposed within the outer perimeter 215. The second ledge can be configured to interface with the second electrode 110.

As shown in FIG. 3A, in some embodiments, the ledges 225 226 can comprise a continuous protrusion extending inward towards a center of the spacer (e.g., internal cavity 220) from an interior surface of the outer perimeter 215. Alternatively, as shown in FIGS. 3B-C, the ledges 225 226 can comprise one or more protrusions extending inward towards the center of the spacer (e.g., internal cavity 220) from an interior surface of the outer perimeter 215. In embodiments where the ledges 225 226 comprise a plurality of protrusions, the protrusions can be coplanar, thus providing a uniform plane for the electrodes 105 110.

The spacer can be made of many different materials known in the art. In some embodiments, the spacer can be made of a non-conductive material, such as plastic or non-conductive polymers. Additionally, in some embodiments, the spacer 115 can be 3D printed, which can allow for an improved manufacturing process.

As shown in FIG. 1, the electrodes 105 110 can comprise a conductive substrate 135 136 and a plurality of carbon nanotubes 125 130. The conductive substrate can be many different conductive materials known in the art, including, but not limited to metals, semiconductors (e.g., silicon, which can be heavily doped), conductive polymers, or combinations of such materials. In some embodiments, the conductive substrate can initially comprise a catalyst layer, which can be used to grow the plurality of carbon nanotubes. The catalyst can be many catalysts known in the art, including, but not limited to, iron, nickel, cobalt, and the like. In some embodiments, the catalyst layer can comprise one or more support and diffusion layers, which can be made of aluminum or titanium. During the carbon nanotube growth process, the catalyst layer can be altered from a continuous catalyst layer across the surface of the conductive substrate to a plurality of catalyst patches 140, as shown in FIG. 1.

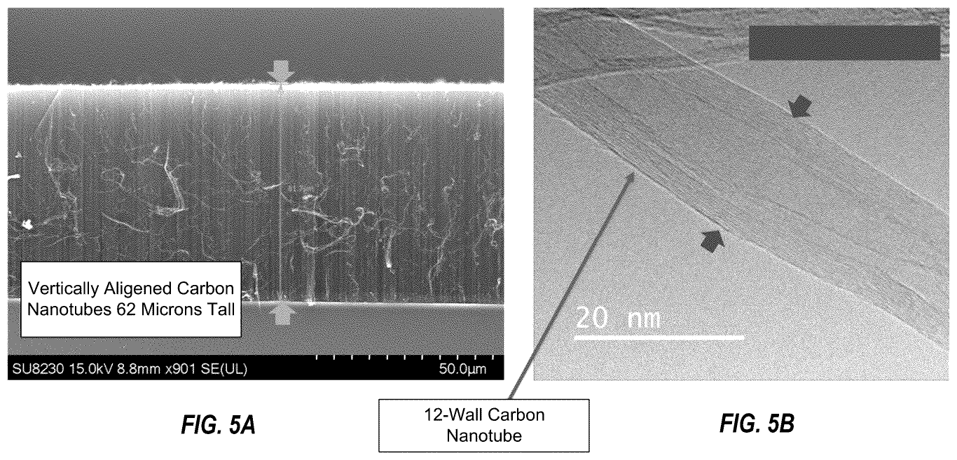

In some embodiments, the carbon nanotubes 125 130 can be multi-walled carbon nanotubes. FIG. 5B provides an image of a 12-wall carbon nanotube. As shown in FIG. 5A, the carbon nanotubes can be substantially parallel with one another and perpendicular to the conductive substrates 135 136 of the electrodes. For example, the first electrode 105 can comprise a first plurality of carbon nanotubes 125 having first ends 126 and opposing second ends 127. The first ends 126 can be positioned proximate the conductive substrate 135 and the second ends 127 can extend to the ionic liquid electrolyte 120. Similarly, the second electrode 110 can comprise a second plurality of carbon nanotubes 130 having first ends 132 and opposing second ends 131. The second ends 131 can be positioned proximate the conductive substrate 136 and the first ends 132 can extend to the ionic liquid electrolyte 120.

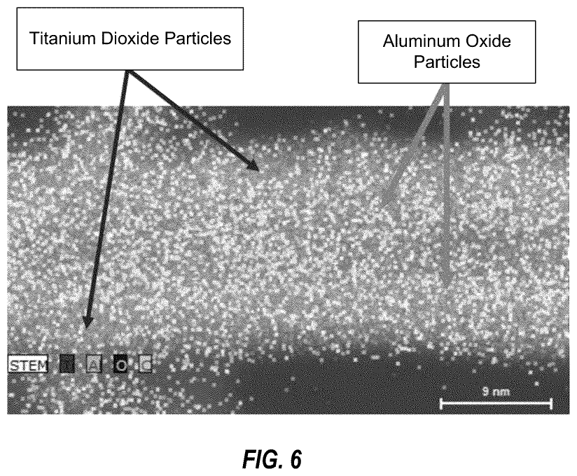

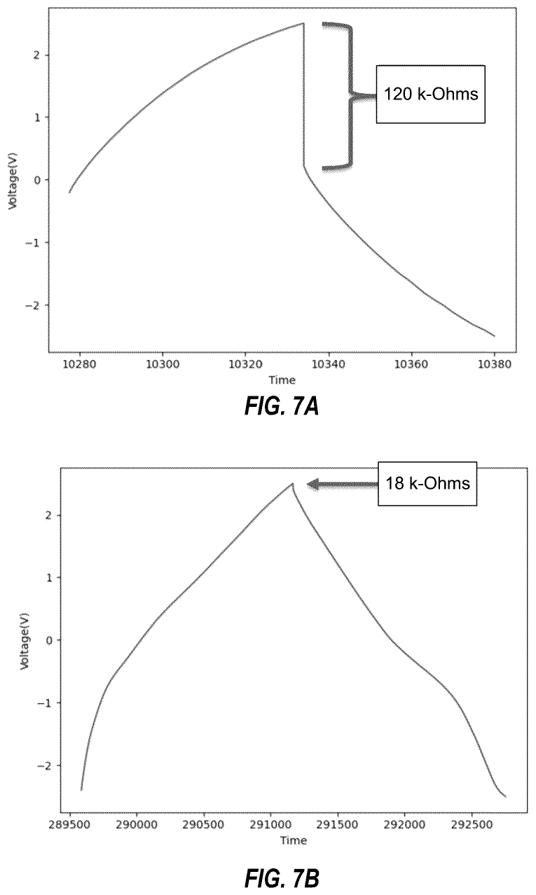

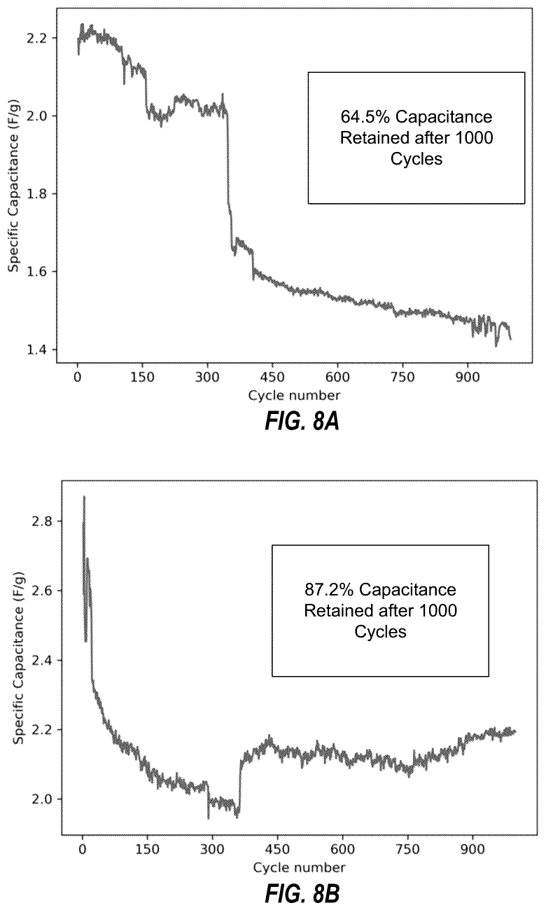

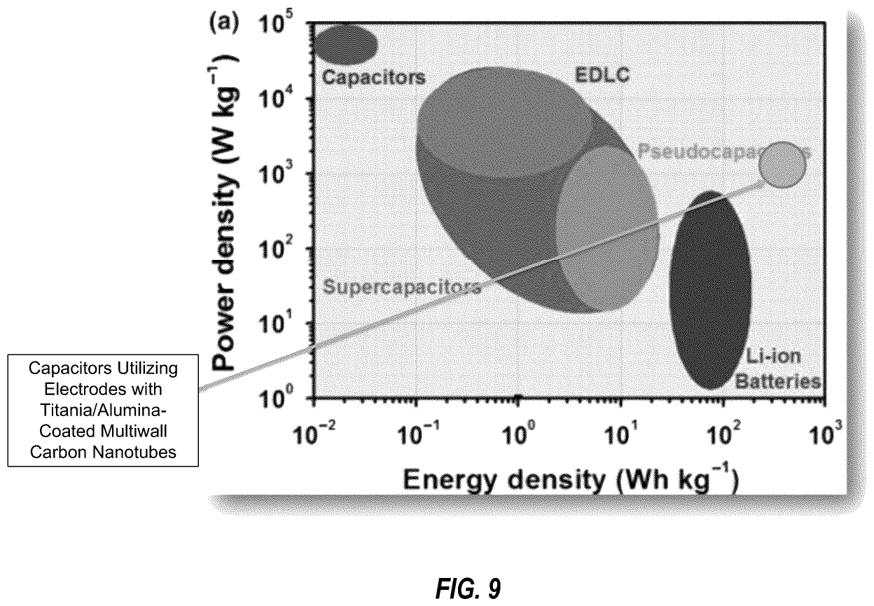

In some embodiments, the electrodes 105 110 can be coated with a pseudocapacitive material, which can enhance the energy and power densities of the capacitors. In some embodiments, the coating can be performed via an atomic layer deposition process. The pseudocapacitive material can be many pseudocapacitive materials known in the art, including, but not limited to, conductive polymers, transition metal oxides, such as aluminum oxide (i.e., alumina) and titanium dioxide (titania), ruthenium (IV) oxide (RuO₂), manganese dioxide, combinations thereof, and the like. In some embodiments, the carbon nanotubes 125 130 can be coated with pseudocapacitive materials. In some embodiments, the carbon nanotubes can be coated with aluminum oxide. The aluminum oxide coating can form aluminum dioxide particle on the carbon nanotubes, which can reduce resistance and increase capacitance. In some embodiments, the carbon nanotubes can be coated with titanium dioxide. The titanium dioxide coating can form titanium dioxide particles on the carbon nanotubes, which can add pseudocapacitance to the capacitor through surface redox reactions with the electrolyte, increasing energy density. In some embodiments, the carbon nanotubes can have a coating of both titanium dioxide and aluminum oxide. In some embodiments, the carbon nanotubes can have a first coating of aluminum oxide over the carbon nanotubes and a second layer of titanium dioxide over the aluminum oxide coating, as shown in the image in FIG. 6. The aluminum oxide layer can increase capacitance by altering the morphology of the titanium dioxide coating to increase pseudocapacitive reactions.

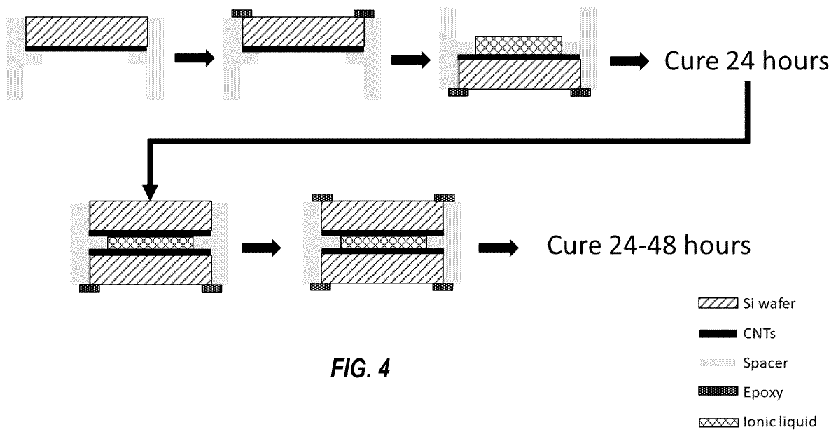

Another embodiment of the present disclosure provides a method of manufacturing a capacitor. The method can comprise: making a first electrode; making a second electrode; making a spacer; coupling the first electrode to a first side of the spacer; filling an internal cavity of the spacer with ionic liquid electrolyte; and coupling the second electrode to the second side of the spacer. Making the electrodes can comprise: providing a conductive substrate (such as a silicon wafer); depositing a catalyst layer on the substrate; and growing a plurality of carbon nanotubes on the catalyst layer (e.g., chemical vapor deposition). FIG. 4 illustrates an exemplary process of assembling the electrodes and ionic liquid electrolyte to the spacer. In some embodiments, making the electrodes can further comprise coating the carbon nanotubes with aluminum oxide and/or coating the carbon nanotubes with titanium dioxide. In some embodiments, coupling the electrodes to the spacer can comprise: epoxying the electrodes to the spacer; allowing the epoxy to cure; and removing (e.g., sanding) excess epoxy.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A capacitor, comprising:
a first electrode;
a second electrode; and
an ionic liquid electrolyte positioned between the first and second electrodes,
a spacer positioned between the first and second electrodes and configured to separate the first electrode from the second electrode.

2. The capacitor of claim 1, wherein the spacer, the first electrode, and the second electrode define an internal cavity, the ionic liquid electrolyte positioned in the internal cavity.

3. The capacitor of claim 1, wherein the spacer comprises a first end, a second end, and an outer perimeter positioned between the first and second ends, and wherein the spacer comprises a first ledge disposed within the outer perimeter, the first ledge configured to interface with the first electrode.

4. The capacitor of claim 3, wherein the first ledge is a continuous protrusion extending inward towards a center of the spacer from the outer perimeter.

5. The capacitor of claim 3, wherein the first ledge comprises one or more protrusions extending inward towards the center of the spacer from the outer perimeter.

6. The capacitor of claim 3, further comprising a second ledge disposed within the outer perimeter, the second ledge configured to interface with the second electrode, and wherein the second ledge is one of a continuous protrusion extending inward towards a center of the spacer from the outer perimeter and one or more protrusions extending inward towards the center of the spacer from the outer perimeter.

7. The capacitor of claim 1, wherein at least one of the first and second electrodes comprise a first plurality of carbon nanotubes proximate the ionic liquid electrolyte.

8. The capacitor of claim 7, wherein the first plurality of carbon nanotubes are coated with a pseudocapacitive material.

9. The capacitor of claim 7, wherein the first plurality of carbon nanotubes are coated with aluminum oxide.

10. The capacitor of claim 7, wherein the first plurality of carbon nanotubes are coated with titanium dioxide.

11. The capacitor of claim 10, wherein the first plurality of carbon nanotubes are coated with aluminum dioxide.

12. A capacitor comprising:
a first electrode;
a second electrode; and
a spacer positioned between and separating the first and second electrodes, the spacer comprising:
a first side coupled to the first electrode;
a second side coupled to the second electrode; and
an outer perimeter between the first and second sides, the outer perimeter, first electrode, and second electrode forming an internal cavity containing a ionic liquid electrolyte.

13. The capacitor of claim 12, wherein the spacer comprises a first ledge disposed on an interior surface of the outer perimeter, the first ledge configured to interface with the first electrode.

14. The capacitor of claim 13, wherein the first ledge is one of a continuous protrusion extending inward towards a center of the spacer from the interior surface of the outer perimeter and a one or more protrusions extending inward towards the center of the spacer from interior surface of the outer perimeter.

15. The capacitor of claim 14, wherein the one or more protrusions are coplanar.

16. The capacitor of claim 12, wherein the first electrode comprises a first plurality of carbon nanotubes proximate the ionic liquid electrolyte, and wherein the second electrode comprises a second plurality of carbon nanotubes proximate the ionic liquid electrolyte.

17. The capacitor of claim 16, wherein the first and second pluralities of carbon nanotubes are coated with a pseudocapacitive material.

18. The capacitor of claim 16, wherein the first plurality of carbon nanotubes are coated with aluminum oxide.

19. The capacitor of claim 18, wherein the first and second pluralities of carbon nanotubes are coated with titanium dioxide.

20. The capacitor of claim 12, wherein the each of the first and second electrodes comprise:
a conductive substrate; and
a plurality of carbon nanotubes adjacent a first side of the conductive substrate, the plurality of carbon nanotubes coated with aluminum oxide and titanium dioxide.
